(19) United States
(12) Patent Application Publication
(10) Pub. No.: US 2026/0159393 A1
(43) Pub. Date: Jun. 11, 2026

(54) METHOD FOR DIRECTLY CONVERTING CARBON DIOXIDE INTO SOLID CARBON BY PHOTOCHEMICAL REACTION

(71) Applicant: NANJING UNIVERSITY, Nanjing City, Jiangsu Province (CN)

(72) Inventors: Zhaosheng LI, Nanjing City, Jiangsu Province (CN); Jingrui JIAN, Nanjing City, Jiangsu Province (CN); Jianyong FENG, Nanjing City, Jiangsu Province (CN); Jun WANG, Nanjing City, Jiangsu Province (CN); Mei ZHU, Nanjing City, Jiangsu Province (CN); Zhigang ZOU, Nanjing City, Jiangsu Province (CN)

(21) Appl. No.: 18/707,561

(22) PCT Filed: Dec. 23, 2022
(86) PCT No.: PCT/CN2022/141206

§ 371 Date: May 3, 2024

(30) Foreign Application Priority Data
Dec. 23, 2021 (CN) 202111586547.0

(51) Int. Cl. C01B 32/05

(52) U.S. Cl. CPC C01B 32/05; C01P 2002/72; C01P 2002/82; C01P 2002/88; C01P 2004/03; C01P 2004/04

(57) ABSTRACT

The present disclosure provides a method for directly converting carbon dioxide into solid carbon by a photochemical reaction. The method includes placing a catalyst containing a transition metal element in a reaction device; introducing raw gas containing the carbon dioxide and hydrogen at a predetermined molar ratio into the reaction device; and performing illumination under a predetermined pressure. In this way, the carbon dioxide can be used as a carbon source to form the solid carbon in a hydrogenation reduction manner through the photochemical reaction, which provides a new method for reclaiming the carbon dioxide. Through the above manner, the method provided by the present disclosure has mild reaction conditions, is implemented at a normal temperature, and can realize a high carbon yield. Moreover, overall operation steps are simple and feasible, the applicability is wide, large-scale fixation and reclamation of the carbon dioxide can be realized.

### TECHNICAL FIELD

The present disclosure relates to the technical field of reclamation of carbon dioxide, and in particular to a method for directly converting carbon dioxide into solid carbon by a photochemical reaction.

### BACKGROUND

With the development of society, the increasing demand for energy has triggered rapid consumption of fossil fuels such as coal, oil, and natural gas. A concentration of carbon dioxide in the atmosphere is increased dramatically in such a process. As the concentration of carbon dioxide, a main component of greenhouse gas, is increased, a series of environmental problems such as global warming and extreme climate changes are caused, which will seriously threaten human survival. Thus, in consideration of human survival and sustainable development, it is of great importance to capture, converting, and utilize carbon dioxide in the atmosphere.

Solid carbon can be subdivided into a variety of products that can be applied to the industry in a wide range. For example, graphite, which is soft, slippery, and excellent in electricity-conductive properties, can be used as a lubricant or made into pencils, electrodes, trolley cables, etc. For another example, carbon nanotubes, excellent in mechanical, electricity-conductive, heat-conductive, and optical properties, have been successfully applied to composites, electronic devices, hydrogen storage materials, electrochemical materials, carbon catalysis, etc. In addition, graphene, excellent in optical, electrical, and mechanical properties, has a significant application prospect in materials science, micro-nano processing, energy, biomedicine, and drug delivery.

At present, carbon dioxide is generally reclaimed to synthesize methane, methanol, dimethyl ether, etc. through a catalytic hydrogenation reaction, synthesize dimethyl carbonate through an esterification reaction, or synthesize urea, cyanuric acid, etc. through an ammoniation reaction. Converting carbon dioxide into solid carbon can be expected to benefit the research and application in environmental protection and energy utilization. However, the majority of existing methods for converting carbon dioxide into solid carbon are suffered from harsh reaction conditions and a low carbon yield, and thus cannot be applied in a wide range. It is a pressing issue to convert carbon dioxide into solid carbon under milder conditions and improve a carbon yield.

In view of above, it is of great importance to design an improved method for converting carbon dioxide into solid carbon, so as to solve the above problems.

### SUMMARY

Aiming at the above defects in the prior art, an objective of the present disclosure is to provide a method for directly converting carbon dioxide into solid carbon through a photochemical reaction. The carbon dioxide and hydrogen are used as raw gas, a substance containing a transition metal element is used as a catalyst, and a catalytic reaction is performed through illumination under a certain reaction pressure. Accordingly, the carbon dioxide can be converted into the solid carbon under a normal temperature condition, and a high carbon yield can be realized.

In order to realize the above objective, the present disclosure provides a method for directly converting carbon dioxide into solid carbon through a photochemical reaction. The method includes:
S1, placing a catalyst in a reaction device, where the catalyst contains a transition metal element;
S2, introducing raw gas into the reaction device, where the raw gas contains the carbon dioxide and hydrogen at a predetermined molar ratio; and
S3, performing the photochemical reaction through illumination under a predetermined pressure to obtain the solid carbon.

As a further improvement of the present disclosure, in S2, the molar ratio of the carbon dioxide to the hydrogen in the raw gas is 20:1-1:20.

As a further improvement of the present disclosure, in S3, the predetermined pressure is 0.01 Mpa-10 Mpa.

As a further improvement of the present disclosure, in S1, the catalyst is a compound containing the transition metal element.

As a further improvement of the present disclosure, in S3, the illumination is supplied by a light source, and the light source is artificial light or natural light.

As a further improvement of the present disclosure, the light source has a light intensity of 0.01 W/cm²-20 W/cm² and a wavelength greater than 300 nm.

As a further improvement of the present disclosure, in S3, an illumination time is 2 h-30 h.

As a further improvement of the present disclosure, in S3, the reaction device is closed or a mobile phase reactor is employed when the illumination is performed.

As a further improvement of the present disclosure, in S2, oxygen is removed from the reaction device through purging with raw gas, purging with inert gas, or vacuumizing before the raw gas is introduced.

As a further improvement of the present disclosure, in S2, the raw gas is introduced as follows:
mixing the carbon dioxide and the hydrogen, and then introducing resulting gas into the reaction device; and alternatively,
introducing the carbon dioxide into the reaction device first, and then introducing the hydrogen into the reaction device in a reaction stage.

Compared with the prior art, the present disclosure has the beneficial effects as follows:
1. According to the method for directly converting carbon dioxide into solid carbon through a photochemical reaction provided by the present disclosure, the carbon dioxide and the hydrogen are introduced into the reaction device as raw gas. Light energy is introduced as an energy input to perform the photochemical reaction in the presence of the catalyst under a certain reaction pressure and certain illumination conditions. Accordingly, the carbon dioxide is successfully converted into the solid carbon, which provides a new idea for reclaiming the carbon dioxide.
2. Based on the method provided by the present disclosure, the carbon dioxide is used as a carbon source to prepare the solid carbon in hydrogenation reduction manner during the photochemical reaction. Accordingly, a yield per pass of a solid carbon product can reach 23% at a normal temperature condition, and a high carbon yield can be realized.
3. The method for directly converting carbon dioxide into solid carbon through a photochemical reaction provided by the present disclosure has mild overall reaction conditions, simplicity, feasibility, wide applicability, and a wide selection range of the catalyst, can realize large-scale fixation and reclamation of the carbon dioxide, and takes a significant role in research and application.

### BRIEF DESCRIPTION OF THE DRAWINGS

FIG. 1 is a comparison graph of an X-ray diffraction (XRD) pattern of a catalyst prepared in Example 1 and a standard pattern of cobalt oxide (Co₃O₄).

FIG. 2 is a scanning electron microscope (SEM) photograph of a solid carbon product obtained in Example 1.

FIG. 3 is a transmission electron microscope (TEM) photograph of the solid carbon product obtained in Example 1.

FIG. 4 is a Raman spectrogram of the solid carbon product obtained in Example 1.

FIG. 5 is a thermogravimetric analysis pattern of the solid carbon product obtained in Example 1.

FIG. 6 is a comparison graph of Raman spectrograms of solid carbon products obtained through catalysts containing different transition metal elements.

FIG. 7 is a comparison graph of Raman spectrograms of solid carbon products obtained at different molar ratios of carbon dioxide to hydrogen in raw gas.

FIG. 8 is a comparison graph of Raman spectrograms of solid carbon products obtained through cobalt-based catalysts having different oxygen contents.

FIG. 9 is a comparison graph of Raman spectrograms of solid carbon products obtained at different pressures.

FIG. 10 is a comparison graph of Raman spectrograms of solid carbon products obtained at different illumination times.

FIG. 11 is a comparison graph of scanning electron microscope (SEM) photographs of solid carbon products obtained at different illumination times.

FIG. 12 is a comparison graph of transmission electron microscope (TEM) photographs of solid carbon products obtained at different illumination times.

FIG. 13 is a comparison graph of thermogravimetric analysis patterns of solid carbon products obtained at different illumination times.

FIG. 14 is a comparison graph of Raman spectrograms of solid carbon products obtained under an illumination condition and a heating condition respectively.

FIG. 15 is a comparison graph of scanning electron microscope (SEM) photographs of solid carbon products obtained under an illumination condition and a heating condition respectively.

### DETAILED DESCRIPTION OF THE EMBODIMENTS

In order to make the objectives, technical solutions, and advantages of the present disclosure clearer, the present disclosure is described in detail below with reference to the accompanying drawings and specific examples.

Herein, it should also be noted that in order to avoid obscuring the present disclosure with unnecessary details, only structures and/or processing steps closely related to the solutions of the present disclosure are shown in the accompanying drawings, and other details not closely related to the present disclosure are omitted.

It should also be noted that the terms “comprise”, “include”, “encompass”, or their any other variations are intended to cover non-exclusive inclusion. Therefore, a process, method, product, or apparatus including a series of elements further includes other elements that are not explicitly listed except for those elements, or further includes elements inherent to such a process, method, product, or apparatus.

The present disclosure provides a method for directly converting carbon dioxide into solid carbon through a photochemical reaction. The method includes:
S1, a catalyst is placed in a reaction device, where the catalyst contains a transition metal element;
S2, raw gas is introduced into the reaction device, where the raw gas contains the carbon dioxide and hydrogen at a predetermined molar ratio; and
S3, the photochemical reaction is performed through illumination under a predetermined pressure to obtain the solid carbon.

In the above manner, light energy may be introduced as an energy input, and the carbon dioxide may be used as a carbon source to form the solid carbon in a hydrogenation reduction manner through the photochemical reaction under the action of the catalyst and a predetermined pressure condition. Accordingly, a new idea is provided for reclaiming the carbon dioxide. A high carbon yield can be realized under mild reaction conditions, and large-scale fixation and reclamation of the carbon dioxide can be realized. The energy crisis is relieved to a certain extent, and a concentration of carbon dioxide in atmosphere is reduced. The present disclosure is conducive to environmental protection and human survival, and takes a significant role in research and application.

In S1, the catalyst may be a compound containing the transition metal element or an elementary transition metal, so as to obtain a solid carbon product. The catalyst is preferably the compound containing the transition metal element. Further preferably, the compound containing the transition metal element may be an oxide. Further preferably, the transition metal element may be an iron element, a cobalt element, a nickel element, or a copper element. Moreover, the catalyst may be commercially available or prepared by oneself, and thus has a wide selection range and may be selected randomly as required.

In step S2, oxygen may be removed from the reaction device before the raw gas is introduced to avoid affecting the reaction in the presence of the oxygen. The oxygen may be removed from the reaction device through purging with raw gas, purging with inert gas, or vacuumizing, so as to realize a required oxygen removal effect.

After the oxygen is removed from the reaction device, the raw gas may be introduced as follows:

The first method is that the carbon dioxide and the hydrogen are mixed at a molar ratio of 20:1-1:20, and then resulting gas is introduced into the reaction device.

The second method is that the carbon dioxide is introduced into the reaction device first to form a carbon dioxide atmosphere. Then, the hydrogen is introduced into the reaction device in a reaction stage. The hydrogen may be introduced at a time or multiple times, or at a certain flow rate as long as the molar ratio of the carbon dioxide introduced initially to the hydrogen introduced in total in the reaction stage is 20:1-1:20.

The above two methods may be employed to convert the carbon dioxide into the carbon source and selected as required. When the carbon dioxide and the hydrogen are mixed and introduced into the reaction device through the first method, the reaction device may be closed in a subsequent illumination process, so that the reaction is performed in a closed state. When the carbon dioxide and the hydrogen are introduced step by step through the second method, a mobile phase reactor may be used as the reaction device, so that the hydrogen is introduced in an illumination process.

In S3, the predetermined pressure is preferably 0.01 Mpa-10 Mpa, and the reaction may also be implemented under a normal pressure. Accordingly, the present disclosure is mild in reaction conditions and easy to implement, and the requirements on the reaction device are not high, so that the requirements of practical application can be satisfied.

The illumination in the step is supplied by a light source. The light source is artificial light or natural light, which may be selected as required actually, and has a wide selection range. The carbon dioxide can also be converted into the solid carbon when a light intensity of the light source is low. However, a surface temperature of the catalyst is too low, so that most of a surface of the catalyst is covered with amorphous carbon. With the increase of the light intensity, graphite carbon may be obtained, and the formation of carbon nanotubes is observed simultaneously. If a light intensity is too high, a surface temperature of the catalyst is too high. Water vapor generated through the reaction is decomposed into hydroxyl radicals under the action of a high temperature and a metal. The hydroxyl radicals may conduct oxidation to etch the carbon nanotubes, so as to hinder the carbon nanotubes from growing. The light intensity of the light source is preferably 0.01 W/cm²-20 W/cm², a wavelength is preferably greater than 300 nm, and an illumination time is preferably 2 h-30 h, so as to ensure that the photochemical reaction is effectively performed, and improve a carbon yield and a product quality.

The solid carbon prepared through the present disclosure may be graphite, the carbon nanotubes, graphene, carbon fibers, etc. By increasing the light intensity or adding an additional temperature field, the surface temperature of the catalyst may reach 1000° C. Accordingly, graphite, graphene (better through a copper based catalyst), and carbon fiber (better through a cobalt based catalyst and an iron based catalyst) products may be obtained, and the form of the solid carbon products may be adjusted.

The method for directly converting carbon dioxide into solid carbon through a photochemical reaction provided by the present disclosure will be described in detail below in combination with specific examples and a comparative example.

### Example 1

A method for directly converting carbon dioxide into solid carbon through a photochemical reaction is provided in the example. The method includes:
S1, cobalt oxide (Co₃O₄) powder is prepared as a catalyst, and 50 mg of the catalyst are placed in a reaction device.

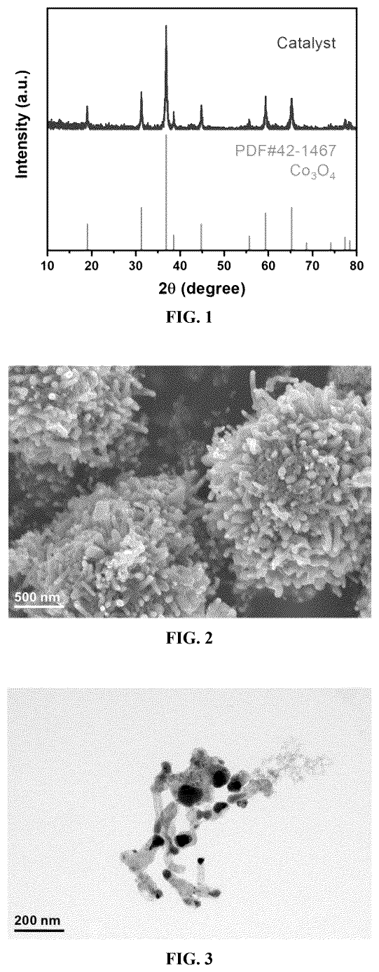

The cobalt oxide (Co₃O₄) powder is prepared as the catalyst through a method as follows:
2 g of cobalt nitrate hexahydrate (Co(NO₃)₃·6H₂O) is added to an alumina boat, and the alumina boat is placed in a muffle furnace; a temperature is increased to 450° C. at a rate of 10° C./min, a temperature is preserved for 2 h, and after the temperature is decreased, a resulting substance is fully ground with a mortar to obtain the cobalt oxide (Co₃O₄) powder. The composition of the powder may be confirmed through a comparison graph of an X-ray diffraction (XRD) pattern shown in FIG. 1.
S2, carbon dioxide and hydrogen are fully mixed at a molar ratio of 1:2 at a normal temperature to obtain raw gas, air in the reaction device is exhausted through purging with raw gas first, and then the raw gas to undergo the reaction is introduced.
S3, illumination is performed with a xenon lamp (having power of 300 W and a light intensity of 2 W/cm²) as a light source at the normal temperature and a normal pressure (0.1 Mpa) for 5h to obtain a solid carbon product.

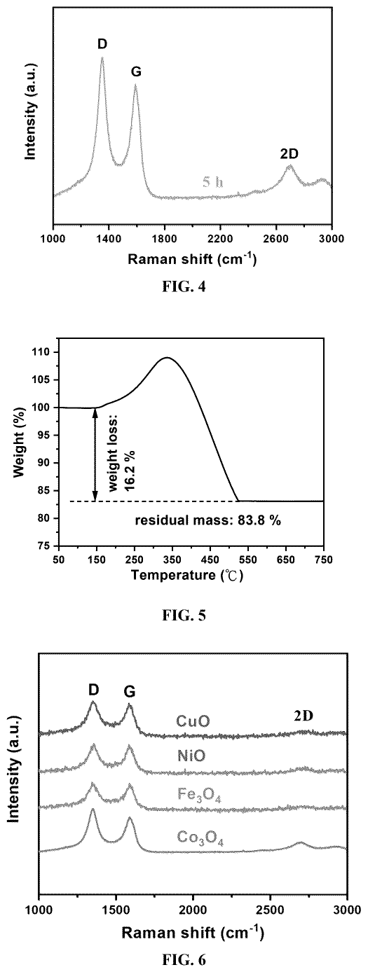

The solid carbon product obtained in the example is indicated through a scanning electron microscope (SEM), a transmission electron microscope (TEM), and a Raman spectrum. The results are shown in FIGS. 2, 3, and 4 respectively. It can be seen from the indication results shown in FIGS. 2, 3, and 4 that the solid carbon product currently prepared is primarily composed of carbon nanotubes, which proves that the method according to the example converts the carbon dioxide into the solid carbon.

The solid carbon product obtained in the example is collected and ground. 30 mg of a ground product are divided into 3 parts (to prevent measurement errors), and a thermogravimetric analysis test is performed to measure weight losses of samples heated in air with a temperature change. The results are shown in FIG. 5. According to a solid product weight loss (16.2%) depicted in FIG. 5, and a use amount (50 mg) of an initial catalyst, a carbon product weight is calculated to be 9.67 mg or so through a formula that carbon product weight-initial catalyst weight×weight loss+residual weight. Then, an amount of substance of the carbon product is calculated to be 0.81 mmol or so through a formula that carbon product molar weight=carbon product weight-carbon element molar weight (12 mg/mmol). Finally, a carbon yield per pass in the example is calculated to be 17.5% through a formula that carbon yield (conversion rate of carbon dioxide to carbon nanotubes)=carbon product molar weight-initial carbon dioxide molar weight (4.6 mmol). It is indicated that the method according to the example can reach a high carbon yield under mild normal-temperature and normal-pressure conditions.

### Examples 2-4

A method for directly converting carbon dioxide into solid carbon through a photochemical reaction is each provided in Examples 2-4. Compared with Example 1, the difference merely lies in that transition metal elements contained in catalysts used are different. Other steps are the same as those in Example 1 and will not be repeated herein. The catalysts used and their reaction results in Examples 1˜4 are shown in Table 1, and a comparison graph of Raman spectra of solid carbon products obtained is shown in FIG. 6.

TABLE 1
Catalysts used and their Reaction Results in Examples 1-4

| Item | Catalyst | Result |
|---|---|---|
| Example 1 | Co₃O₄ | Solid carbon is generated (I_{D}/I_{G} = 1.233) |
| Example 2 | Fe₃O₄ | Solid carbon is generated (I_{D}/I_{G} = 1.155) |
| Example 3 | NiO | Solid carbon is generated (I_{D}/I_{G} = 1.121) |
| Example 4 | CuO | Solid carbon is generated (I_{D}/I_{G} = 1.114) |

It can be seen from Table 1 and FIG. 6 that the carbon dioxide can be successfully converted into the solid carbon with compounds containing different transition metal elements as the catalysts. However, values of I_{D}/I_{G} are different, indicating that there are certain differences in product quality. I_{D} denotes an intensity of peak D that represents defects of a carbon atom lattice. I_{G} denotes an intensity of peak G that represents a graphitization degree of a carbon atom. Generally, the lower the value of I_{D}/I_{G} is, the higher the quality of the solid carbon product obtained is.

### Examples 5-9

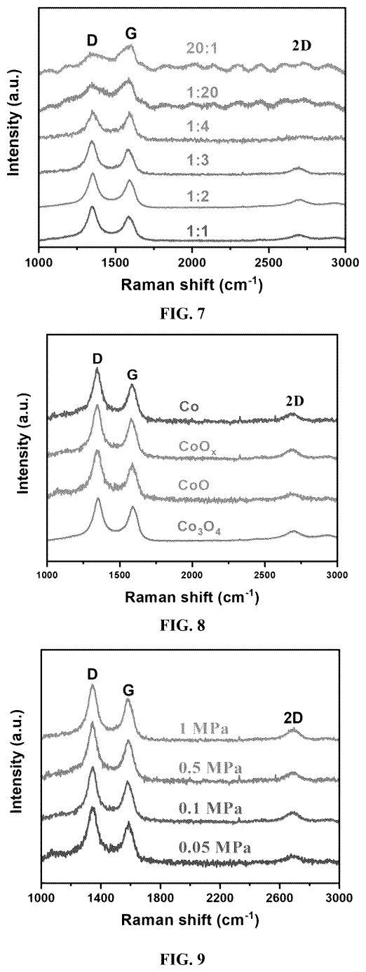

A method for directly converting carbon dioxide into solid carbon through a photochemical reaction is each provided in Examples 5-9. Compared with Example 1, the difference merely lies in that molar ratios of carbon dioxides to hydrogen in raw gas are different. Other steps are the same as those in Example 1 and will not be repeated herein. The molar ratios of the carbon dioxides to the hydrogen in Examples 1 and 5-9 and their reaction results are shown in Table 2, and a comparison graph of Raman spectra of solid carbon products obtained is shown in FIG. 7.

TABLE 2
Molar Ratios of Carbon Dioxides to Hydrogen and
their Reaction Results in Examples 1 and 5-9

| | Molar ratio of | |
|---|---|---|
| | carbon dioxide | |
| | to hydrogen | |
| Item | in raw gas | Result |
| Example 1 | 1:2 | Solid carbon is generated (I_{D}/I_{G} = 1.241) |
| Example 5 | 1:1 | Solid carbon is generated (I_{D}/I_{G} = 1.384) |
| Example 6 | 1:3 | Solid carbon is generated (I_{D}/I_{G} = 1.382) |
| Example 7 | 1:4 | Solid carbon is generated (I_{D}/I_{G} = 1.045) |
| Example 8 | 20:1 | Solid carbon is generated (I_{D}/I_{G} = 0.753) |
| Example 9 | 1:20 | Solid carbon is generated (I_{D}/I_{G} = 0.591) |

It can be seen from Table 2 and FIG. 7 that the carbon dioxide can be successfully converted into the solid carbon by adjusting the molar ratio of the carbon dioxide and the hydrogen within a certain range, but there are certain differences in product quality.

### Examples 10-12

A method for directly converting carbon dioxide into solid carbon through a photochemical reaction is each provided in Examples 10-12. Compared with Example 1, the difference merely lies in that ratios of metal cobalt elements to oxygen elements contained in cobalt based catalysts are different. Other steps are the same as those in Example 1 and will not be repeated herein. The components of the cobalt based catalysts and their reaction results in Examples 1 and 10-12 are shown in Table 3, and the comparison graph of Raman spectra of solid carbon products obtained are shown in FIG. 8.

TABLE 3
Components of Cobalt based Catalysts and their
Reaction Results in Examples 1 and 10-12

| Item | Catalyst | Result |
|---|---|---|
| Example 1 | Co₃O₄ | Solid carbon is generated (I_{D}/I_{G} = 1.226) |
| Example 10 | Co | Solid carbon is generated (I_{D}/I_{G} = 1.344) |
| Example 11 | CoO | Solid carbon is generated (I_{D}/I_{G} = 1.241) |
| Example 12 | CoOₓ | Solid carbon is generated (I_{D}/I_{G} = 1.258) |

The catalyst CoOₓ in Example 12 is obtained by burning metal cobalt powder in air.

It can be seen from Table 3 and FIG. 8 that the carbon dioxide can be successfully converted into the solid carbon through the cobalt based catalysts formed by the cobalt element and the oxygen element at different molar ratios, but there are certain differences in product quality.

### Examples 13-15

A method for directly converting carbon dioxide into solid carbon through a photochemical reaction is each provided in Examples 13-15. Compared with Example 1, the difference merely lies in that pressures in S3 are different. Other steps are the same as those in Example 1 and will not be repeated herein. The reaction pressures and their reaction results in Examples 1 and 13-15 are shown in Table 4, and the comparison graph of Raman spectra of solid carbon products obtained are shown in FIG. 9.

TABLE 4
Pressures and their Reaction Results in Examples 1 and 13-15

| Item | Pressure | | Result |
|---|---|---|---|
| Example 1 | 0.1 | Mpa | Solid carbon is generated (I_{D}/I_{G} = 1.215) |
| Example 13 | 0.05 | Mpa | Solid carbon is generated (I_{D}/I_{G} = 1.226) |
| Example 14 | 0.5 | Mpa | Solid carbon is generated (I_{D}/I_{G} = 1.233) |
| Example 15 | 1 | Mpa | Solid carbon is generated (I_{D}/I_{G} = 1.217) |

It can be seen from Table 4 and FIG. 9 that the carbon dioxide can be successfully converted into the solid carbon by adjusting the pressure within a certain range, but there are slight differences in product quality, and a conversion rate of the carbon dioxide is increased slightly with the increase of pressure.

### Examples 16-19

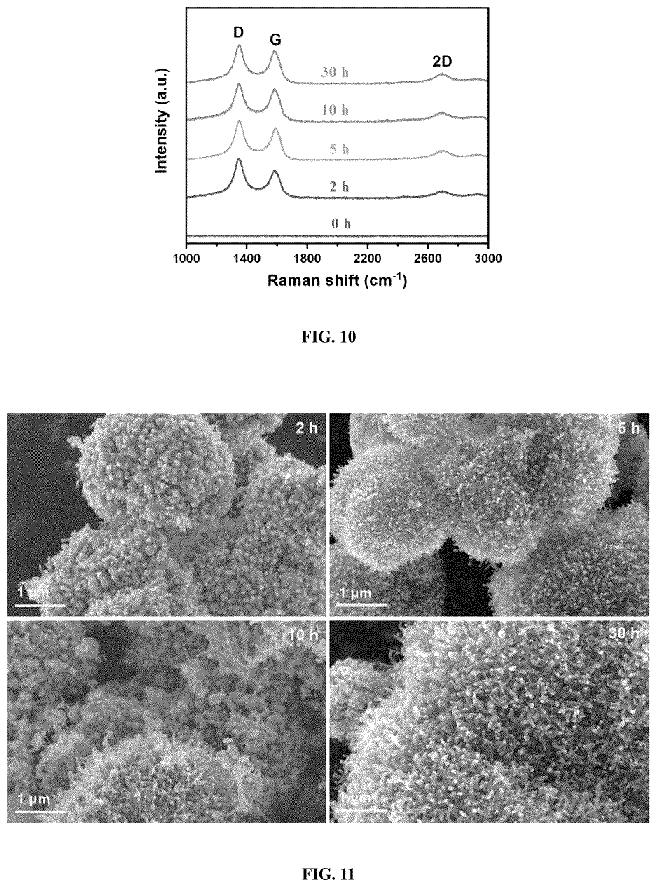

A method for directly converting carbon dioxide into solid carbon through a photochemical reaction is each provided in Examples 16-19. Compared with Example 1, the difference merely lies in that illumination times are different. Other steps are the same as those in Example 1 and will not be repeated herein. The illumination times and their reaction results in Examples 1 and 13-16 are shown in Table 5, and the comparison graph of Raman spectra of solid carbon products obtained are shown in FIG. 10.

TABLE 5
Illumination Times and their Reaction
Results in Examples 1 and 16-19

| | Illumination | | |
|---|---|---|---|
| Item | time | | Result |
| Example 1 | 5 | h | Solid carbon is generated (I_{D}/I_{G} = 1.229) |
| Example 16 | 0 | h | No reaction is started |
| Example 17 | 2 | h | Solid carbon is generated (I_{D}/I_{G} = 1.368) |
| Example 18 | 10 | h | Solid carbon is generated (I_{D}/I_{G} = 1.178) |
| Example 19 | 30 | h | Solid carbon is generated (I_{D}/I_{G} = 1.172) |

It can be seen from Table 5 and FIG. 10 that when the illumination time is 0 h, no photochemical reaction may be performed, and no carbon dioxide can be converted into solid carbon. When the illumination time is increased to 2 h, the solid carbon may be generated, and the carbon dioxide can be successfully converted into the solid carbon with the further increase of illumination time.

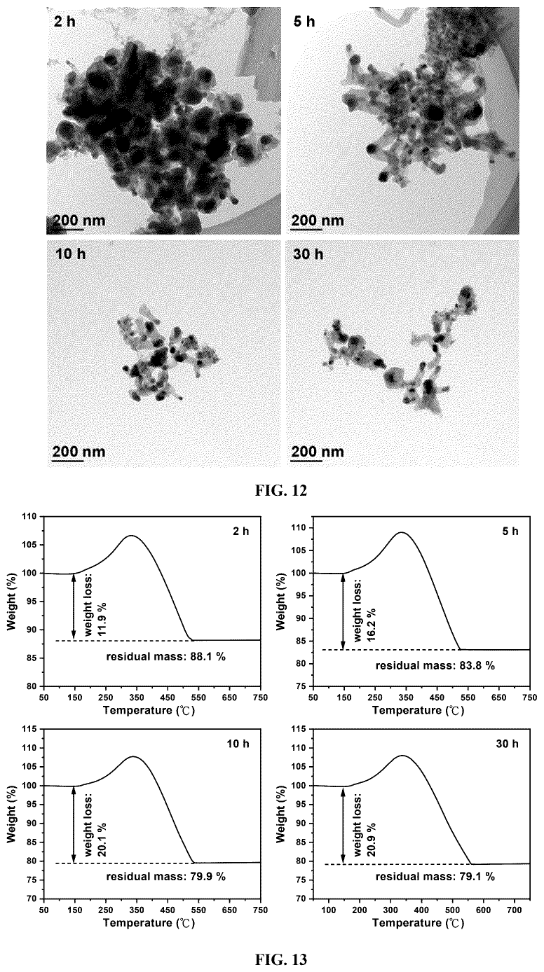

Further, the solid carbon generated in Example 1 and solid carbon products obtained in Examples 17-19 are indicated through the scanning electron microscope (SEM) and the transmission electron microscope (TEM), and undergo the thermogravimetric analysis. The results are shown in FIGS. 11, 12, and 13, respectively. As shown in FIG. 13, when the illumination times are 2 h, 5 h, 10 h, and 30 h, the corresponding carbon yields are 12.2%, 17.5%, 22.7%, and 23.9% respectively. It can be seen from Table 5 and FIGS. 10-13 that the carbon yield and product quality of the solid carbon product formed are low when the illumination time is short. With the extension of illumination time, the carbon yield and product quality are gradually improved. After the illumination time reaches a certain extent, the carbon yield and product quality are not affected remarkably with the further extension of illumination time.

### Comparative Example 1

A method for directly converting carbon dioxide into solid carbon is provided in the comparative example. Compared with Example 1, the difference merely lies in that the energy supply form is different. In Example 1, the light energy is introduced as energy, while in the comparative example, energy is supplied through heating. Other steps are the same as those in Example 1 and will not be repeated herein.

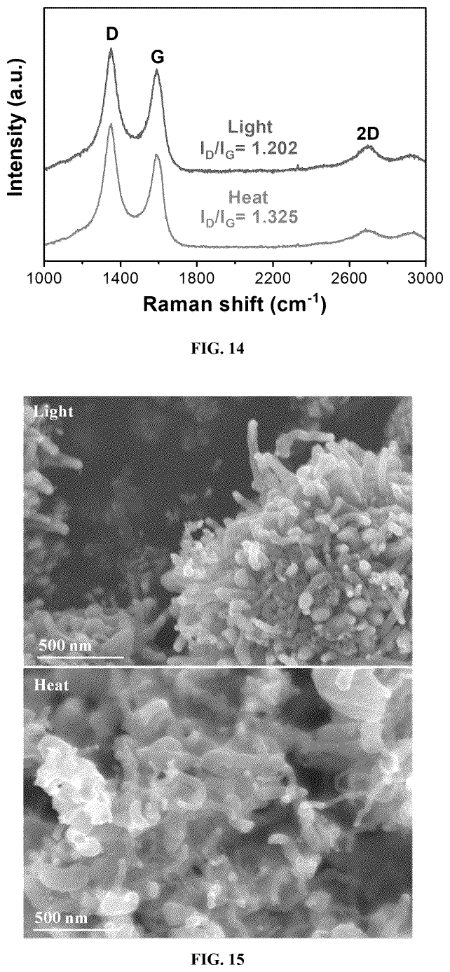

A surface temperature of the catalyst under an illumination condition in Example 1 is measured to be 400° C. or so through an infrared thermal imager. Moreover, a temperature of the gas in a reaction system in Example 1 is measured to be 60° C. or so through a thermocouple. In the comparative example, the reaction device is heated to 400° C. as a whole according to the surface temperature of the catalyst under the illumination condition in Example 1. A solid carbon product obtained is indicated through a Raman spectrum and a scanning electron microscope (SEM) and compared with that in Example 1. The results are shown in FIGS. 14 and 15 respectively.

It can be seen from FIGS. 14 and 15 that although the carbon dioxide can also be converted into the solid carbon by supplying the energy through heating, in such a method, the temperature of an entire reaction system is required to be increased, leading to high energy consumption, and there are obvious differences in the form of the solid carbon finally obtained. The value of I_{D}/I_{G} of the carbon nanotubes obtained through illumination in Example 1 is lower than that of carbon nanotubes obtained through heating in Comparative Example 1. Therefore, it is indicated that the carbon nanotubes obtained through illumination in Example I have higher quality than those obtained through heating.

In conclusion, the present disclosure provides the method for directly converting carbon dioxide into solid carbon through a photochemical reaction. The method includes the catalyst containing the transition metal element is placed in the reaction device; the raw gas containing the carbon dioxide and the hydrogen at the predetermined molar ratio is introduced into the reaction device; and the illumination is performed under the predetermined pressure. In this way, the carbon dioxide may be used as the carbon source to form the solid carbon in a hydrogenation reduction manner through the photochemical reaction, which provides a new method for reclaiming the carbon dioxide. Through the above manner, the method provided by the present disclosure has mild reaction conditions, is implemented at the normal temperature, and can realize the high carbon yield. Moreover, overall operation steps are simple and feasible, the applicability is wide, large-scale fixation and reclamation of the carbon dioxide can be realized, and thus the method takes a significant role in research and application.

The above examples are merely used to describe the technical solutions of the present disclosure and are not intended to limit the present disclosure. Although the present disclosure is described in detail with reference to preferred examples, those of ordinary skill in the art should understand that they can make modifications or equivalent substitutions to the technical solutions of the present disclosure without departing from the spirit and scope of the technical solutions of the present disclosure.

What is claimed is:

1. A method for directly converting carbon dioxide into solid carbon by a photochemical reaction, comprising:
S1, placing a catalyst in a reaction device, wherein the catalyst contains a transition metal element;
S2, introducing raw gas into the reaction device, wherein the raw gas contains the carbon dioxide and hydrogen at a predetermined molar ratio; and
S3, performing the photochemical reaction through illumination under a predetermined pressure to obtain the solid carbon.

2. The method for directly converting carbon dioxide into solid carbon by a photochemical reaction according to claim 1, wherein in S2, the molar ratio of the carbon dioxide to the hydrogen in the raw gas is 20:1-1:20.

3. The method for directly converting carbon dioxide into solid carbon by a photochemical reaction according to claim 1, wherein in S3, the predetermined pressure is 0.01 Mpa-10 Mpa.

4. The method for directly converting carbon dioxide into solid carbon by a photochemical reaction according to claim 1, wherein in S1, the catalyst is a compound containing the transition metal element.

5. The method for directly converting carbon dioxide into solid carbon by a photochemical reaction according to claim 1, wherein in S3, the illumination is supplied by a light source, and the light source is artificial light or natural light.

6. The method for directly converting carbon dioxide into solid carbon by a photochemical reaction according to claim 5, wherein the light source has a light intensity of 0.01 W/cm²-20 W/cm² and a wavelength greater than 300 nm.

7. The method for directly converting carbon dioxide into solid carbon by a photochemical reaction according to claim 1, wherein in S3, an illumination time is 2 h-30 h.

8. The method for directly converting carbon dioxide into solid carbon by a photochemical reaction according to claim 1, wherein in S3, the reaction device is closed or a mobile phase reactor is employed when the illumination is performed.

9. The method for directly converting carbon dioxide into solid carbon by a photochemical reaction according to claim 1, wherein in S2, oxygen is removed from the reaction device through purging with raw gas, purging with inert gas, or vacuumizing before the raw gas is introduced.

10. The method for directly converting carbon dioxide into solid carbon by a photochemical reaction according to claim 1, wherein in S2, the raw gas is introduced as follows:
mixing the carbon dioxide and the hydrogen, and then introducing resulting gas into the reaction device; and alternatively;
introducing the carbon dioxide into the reaction device first, and then introducing the hydrogen into the reaction device in a reaction stage.
